(19) United States
(12) Patent Application Publication
(10) Pub. No.: US 2017/0298267 A1
(43) Pub. Date: Oct. 19, 2017

(54) Polymeric material particles and its synthesis process

(71) Applicant: CONSEJO NACIONAL DE INVESTIGACIONES CIENTIFICAS Y TECNICAS (CONICET), Buenos Aires (AR)

(72) Inventors: Silvia Nair GOYANES, Provincia de Buenos Aires (AR); Norma Beatriz DACCORSO, Buenos Aires (AR); Joana Elisa TASQUE, Provincia de Buenos Aires (AR)

(21) Appl. No.: 15/392,754

(22) Filed: Dec. 28, 2016

(30) Foreign Application Priority Data
Dec. 28, 2015 (AR) 20150104301

(51) Int. Cl. C09K 8/80; C08K 3/041; C08K 3/00; C08K 3/04

(52) U.S. Cl. CPC C09K 8/80; C08K 3/04; C08K 3/041; C08K 3/00; C08K 2201/011

(57) ABSTRACT

The present invention relates to new materials composed of reticulate polymer loaded with micro- or nano-loads which result in particles or microparticles to be used in fracking muds for secondary extraction of gas and oil.

### TECHNICAL FIELD

The instant invention relates to the synthesis of ultra-light crosslinked co-polymers and its method of synthesis. In particular, the instant invention relates to new materials composed of reticulate polymer loaded with micro- or nano-loads which result in particles or microparticles to be used in fracking muds for secondary extraction of gas and oil.

### STATE OF THE ART

The state of the art relative to microparticles used in fracking muds for secondary extraction of gas and oil is profuse. Special sands are the most widespread for this use, although a large number of documents has been retrieved in which use of polymers for elaboration of these microparticles, among which the most relevant are the following: US2007181302, EP2018405, U.S. Pat. No. 8,361,934, U.S. Pat. No. 6,248,838, U.S. Pat. No. 6,451,953, U.S. Pat. No. 7,928,042, U.S. Pat. No. 5,403,821, U.S. Pat. No. 8,822,386, U.S. Pat. No. 8,469,118, U.S. Pat. No. 8,278,373, US2006046937, US20140090850, US20110214862, US20100022419, US20090264321.

For example, R. L. Albright's patent “Chain entanglement crosslinked proppants and related uses”, U.S. Pat. No. 6,248,838 B1 of 2001, describes the synthesis of polymers with entangled chains. In the polymerization, at least one monomer and at least one initiator are used in an immiscible liquid medium for forming a fluid dispersion and thus produce the starting of the reticulate polymer chain; the resulting polymer can be used as proppants, as ball bearings, as monolayers, and for drilling mud applications. The initiator is mixed with the monomers, and then it is dispersed in the liquid medium. It decomposes within said dispersion for activating the polymerization and producing the crosslinking of the chains. The crosslinking degree is increased with the increase of the number of growing radical chains per minute, through acceleration of the decomposing degree of the initiator. As goal of the invention, the crosslinked chains are defined as an irreversible physical entanglement of the polymeric chains, in which two or more polymers chains are physically entangled. It is remarked that in the fabrication process the temperature increases with a 0.33° C./min ramp. The mixture is subjected to agitation from 105 to 125 rpm yielding particle sizes between 300 and 400 microns and it is indicated that lower speeds can yield larger sizes. Relative to the reagents, styrene is used as monomers and divinylbenzene is used as crosslinking agent; a polymer is used as dispersant (it is not disclosed which polymer). In the aqueous phase composition sodium hydroxide is used, achieving a basic pH. In the aqueous phase gelatin is used in addition to a 0.3% w/w of dispersant polymer. Several different initiators are claimed, such as azo compounds, although in Tables 2 and 3, when describing the organic phase composition, Vaso 52 and Vaso 64 are used as initiators. In the process of manufacturing micro- or nano-loads are not used. The resulting material are spherical particles from 0.1 to 5 millimeters having a density between 1.040 to 1.150 g/ml.

On the other hand, R. L. Albright's patent, “Chain entanglement crosslinked polymers”, U.S. Pat. No. 6,451,953 B1, from 2002 describes the formation of crosslinked polymers through use of agents which allow for different degrees of crosslinking. Rigidity of the polymer is related with use of high levels or concentration of polyfunctional crosslinking agents. Polymerization in suspension generates spherical particles, its size varying depending on the physical and chemical methodologies used. Most molecules presenting a vinyl group can be crosslinked achieving a rigid polymer by divinylbenzene co-polymerization. This patent focuses in formation of a spherical, rigid polymer, such as to reduce the work energy and enhance the mechanical disadvantages. Several different crosslinking agents which could be used are mentioned, splitting those in groups: substituted acrylates; pentaerythritol family; substituted ethylene glycol; bis(methacrylamide), with substitution in nitrogen-bound groups; bis(acrylamide), with substitution in nitrogen-bound groups; polyethylene glycol dimethacrylate, polyethylene glycol diacrylate. Between 1 and 10% by weight of initiator is used relative to the monomers. In polymerization, dispersant are used, such as cellulose polymers, or sodium polyacrylates of a moderate size. For enhancing the residing time of the “drops” into the suspension, protecting colloids such as gelatin are used. The polymerization is carried out in nitrogen atmosphere as to inactivate the phenolic free radicals of the inhibitor in the monomer. The inhibitors can be removed from the monomer before use, through sodium hydroxide extractions. Elasticity or rigidity of the material is controlled with the crosslinking degree achieved. This patent is similar to the one discussed above, although it uses sodium polyacrylate of molecular weight between 60,000 and 250,000 Daltons such as Acumer 1510™ (Rohm and Haas Co.), Sokalan PA 80S™, and Sokalan PA 110S™, (BASF Corp.); cellulosic polymers such as Culminal CMC-2000™ (Aqualon), hydroxycellulose such as Natrosol™ (Aqualon), and hydroxypropylcellulose such as Klucel™'s (Aqualon) and poly(N,N-dialyl or N,N-dimethylammonium chloride) Cat-Floc B™ (Calgon Corp.) as dispersant polymer. The formulation examples are identical to the previous patent. Regarding the resulting material, it has a density between 1.040 and 1.150 g/ml.

Patent application US2012/0202921 by BICERANO and ALBRIGHT, from 2012, “THERMOSET NANOCOMPOSITE PARTICLES, PROCESSING FOR THEIR PRODUCTION, AND THEIR USE IN OIL AND NATURAL GAS DRILLING APPLICATIONS”, describes the manufacturing process with addition of micro- and nano-load initially mixing the load with the non-crosslinking monomer, the initiator and the dispersant. In regard to the reagents, hydroxyethylcellulose 0.46% w/w and gelatin 0.23% w/w are used as dispersant agent. The salts employed are sodium carbonate (0.46%) and sodium nitrite (0.29% w/w). It claims the divinylbenzene which is used at percentages between 3 and 35% of the starting monomers mixture. In the example of Table 2, 15.56% of divinylbenzene and 0.49% w/w of lampblack are used. Use of nano-loads with fractions in volume between 0.1 and 1.5% is described. It uses the disperbyk-161 in the organic phase for dispersing the lampblack. Although azo compounds are claimed when mentioning the different initiators, when describing the composition of the organic phase in tables 2 and 3 it uses Vaso 52 and Vaso 64 as initiators. Regarding the resulting material it has a density between 1,040 and 1,150 g/ml.

No previous disclosures have been found describing the use of ceramic oxides and carbon nanotubes, or combinations thereof, as nano-loads in the synthesis of polymeric microparticles for use in fracking muds for secondary extraction of gas and oil, let alone the combined use of those.

Neither it has been found, among the particles reported in the prior art for use in the secondary oil retrieval from fracture, polymeric microparticles to which the density can be adjusted to essentially that of the fracturing liquid that is injected under pressure. The instant invention provides a microparticle designed and synthesized in such a way that it has a density that is the same of the water, which is the fluid preferably used in this technology. The density of the microcapsules of the instant invention is around that of the water (from 0.95 to 1.04 g/ml). The advantages of having a density similar to the one of the fluid are as follows:

High density particles usually have decanting problems, while small particles of density similar to that of the fluid not only avoid that problem but also do not change the rheology of the fluid of matter. Particles with a high Reynolds number generate the occurrence of vortices downstream the particles, while those with a low Reynolds number tend to attenuate this effect. The effect is proportional to the densities difference between the particle and the fluid.

Furthermore, particles with density similar to that of the fluid result in a perfect suspension of the particles in the fluid, which leads to the Stokes number depending only on the particle's diameter.

A feature which has not been reported for polymeric microparticles for use in fracking, and that the instant invention has, is the fact of being able to withstand pressures of 20,000 psi with a loss by breakage below 14%. This fact, which is not minor when using in fracturing rocks, would allow operating systems with pressures higher than those currently used.

### BRIEF DESCRIPTION OF THE DRAWINGS

FIG. 1: Image of one of the groups of the particles of the instant invention.

FIG. 2: Electron microscopy of the particles of the instant invention.

FIG. 3: Electron microscopy wherein breakage of the spheres (developed material) subjected to 20,000 psi can be observed.

### BRIEF DESCRIPTION OF THE INVENTION

The polymeric material particle, main object of the instant invention, suitable for hydraulic fracture in secondary extraction of gas and oil comprises a crosslinked polymer and loads which can be micro-loads at a concentration of up to 0.13% (w/w); or nanoloads at a concentration of up to 0.03% (w/w); or a combination of nano-loads and micro-loads at a concentration of up to 0.13% (w/w). Wherein said particle comprises a density similar to that of water of around 1.0 g/ml, preferably a density of up to 1.04 g/ml, more preferably a density between 0.95 and 1.04 g/ml. Additionally, said loads are preferably selected from the group comprising lampblack, carbon nanotubes, ceramic nanoparticles, and combinations thereof; and more preferably comprise carbon nanotubes and ceramic nanoparticles.

This particle of the instant invention is preferably a microparticle and preferably has a mass loss below 2% when subjected to the action of organic solvents selected from the group comprising acetone, toluene, octane and tetrahydrofurane; a mass loss below 2% when subjected to the action of organic acids such as hydrochloric acid; and a mass loss below 14% when subjected to a pressure of 20,000 psi.

Another preferred feature of the instant invention is that said particle of the invention comprises a reticulate polymeric material wherein the polymer has a repetitive structure of formula I:

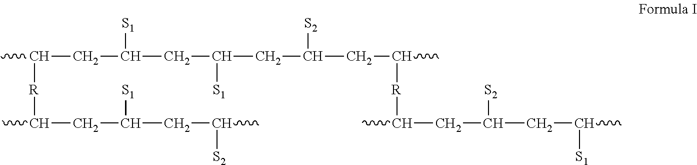

wherein S1 and S2 are olefins substituent groups, R2 is an alkyl or aryl of a crosslinking monomer.

Another object of the instant invention is a process for obtaining said particle of the invention comprising a polymerization in suspension which comprises the following steps:
a. mixing a stabilizer, preferably a neutral inorganic salt at a concentration lower than 4% by weight as salt and a dispersant in water, and heating, preferably at neutral pH;
b. adding to the aqueous solution of step “a” a mixture of at least one monomer, loads and an initiator;
c. reacting the mixture at a temperature higher than 50° C. under constant agitation and for at least 3 hours;
d. once the polymerization reaction is completed the obtained particles of the invention are filtrated and washed with water.
   wherein, preferably in step “a” said stabilizer is selected from the group comprising sodium chloride, potassium chloride, an inorganic salt and mixtures thereof; while said dispersant is selected from the group comprising polyvinylic alcohol, sodium polyacrylates, cellulose polymers, hydroxyethyl cellulose (Natrosol), hydroxypropyl cellulose (Klucel), poly(N,N-dialyl-N,N-dimethyl ammonium chloride) (Cat-Floc B), gelatin, polyalcohols, or combinations thereof. Furthermore, said process is preferably isothermal and is carried out at a temperature of at least 50° C., more preferably at a temperature of 70° C. In a preferred embodiment said mixture of step “b” comprises at least two monomers; being a first monomer a bis-olefin selected from the group comprising polyfunctional acrylates, trimethacrylate, trimethylpropane diacrylate, pentaerythritol tetramethacrylate, divinylbenzene, ethyleneglycol dimethacrylate, and combinations thereof at a concentration of between 20 and 50% by weight of the monomer; and a second monomer being a mono-olefin selected from the group comprising acrylates, vinyl acetate, styrene, vinylnaphthalenes, vinyl toluene, allylic esters, vinyl chloride olefins, and combinations of the aforementioned. Wherein, preferably said two or more monomers have a vinyl group.

Additionally, in a preferred embodiment the initiator of the mixture of step “b” comprises azobisisobutyronitrile (AIBN) and said loads of the step “b” are selected from the group comprising lampblack, carbon nanotubes, ceramic nanoparticles, and combinations of any of the aforementioned. Wherein, more preferably, said loads of step “b” are nano-loads and comprise carbon nanotubes and ceramic nanoparticles; or said loads of step “b” are micro-loads and comprise a concentration of between 0.1 and 0.2% w/w relative to the weight of the monomers.

In an alternative embodiment of the instant invention, said loads of step “b” are nano-loads and comprise a concentration lower than 0.03% w/w, equivalent to 0.015% v/v. In another alternative embodiment said loads of step “b” comprise a combination of micro-loads at a concentration lower than 0.12% w/w and nano-loads at a concentration of up to 0.01% w/w.

In another preferred alternative embodiment, the step “b” of the process of the invention comprises dispersing said loads in monomers solution under sonication in absence of dispersant.

Additionally, in the process of the instant invention the aqueous phase resulting from the reaction medium can be re-used. Wherein said water of step “a” comprises the aqueous phase of a reaction medium used in a previous polymerization. Furthermore, the agitation of step “c” comprises preferably at least a rotation speed in the order of 850 rpm during the manufacturing process.

### DETAILED DESCRIPTION OF THE INVENTION

Sphericity of the particles of the instant invention is achieved through a polymerization in suspension, wherein the polymerization consists of two phases, one aqueous and the other organic, under agitation. Size of the particles depends on a series of experimental parameters such as temperature, agitation, and initiator. The hardness of said particles depends on the type, amount of crosslinking agent and the medium in which the polymerization in suspension takes place.

The polymerization process for obtaining the ultralight crosslinked polymer particles of the instant invention is a polymerization in suspension wherein the organic phase is constituted by a mixture of two or more monomers: one of those is bifunctional for promoting the reticulation and micro- and nano-loads for reducing the static, an initiator (trimers, oligomers, or a low-molecular weight polymer can be added as dispersant of the organic phase) and an aqueous phase with dispersant agent. The resulting material has a density between 0.95 and 1.04 g/ml.

Accordingly, the instant invention encompasses a reticulate composite material in which the polymer presents a repetitive structure of formula I:

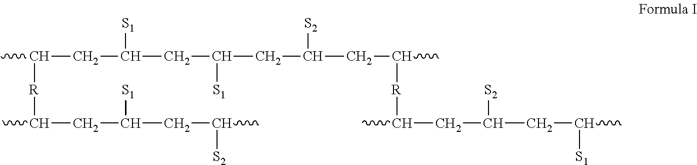

wherein S₁ and S₂ are olefin substituent groups, R₂ is an alkyl or aryl of the crosslinking monomer.

As a generic example, a way to put into practice the instant invention is presented:

A reactor is used which has the following features:

1) Construction of the Reactor:
Reactor which can be cylindrical
Heating blanket for the reactor
Mechanical agitator, with corresponding stand
Agitating rod
Nitrogen input (g)
Thermocouple with temperature controller
Cooler

Reagents to be Used:
Distilled water/residual waters from polymerization
Polyvinylic alcohol (+99.9% hydrolized, Sigma-Aldrich)
Sodium chloride (NaCl)
Mono-olefinic monomer/s
Divinylbenzene (DVB)
Azobisisobutyronitrile (AIBN)
Lampblack/carbon nanotubes/carbon nanotubes plus ceramic nanoparticles smaller than 50 nm

Process:

Polyvinylic alcohol (PVA) and sodium chloride (NaCl) are weighted in a scale and added to the reactor, along with the corresponding water volume (distilled and residual water). Then, agitation is started at about 850 rpm and the heating mat connected to a thermocouple with temperature controller is turned on. The solution is heated to more than 50° C., preferably 70° C., wherein said process requires about 30 min.

Separately, the monomeric phase is prepared, which consists of two or more monomers, mono-olefin/s and a di-olefin, a initiator, AIBN, whose optimal activation temperature is the reaction temperature (70° C.), a dispersant can be added such as low molecular weight polystyrene. For preparation of the monomeric phase, it is first required the extraction of the inhibitors present in each of the commercial monomers. Said process consists of the following steps:

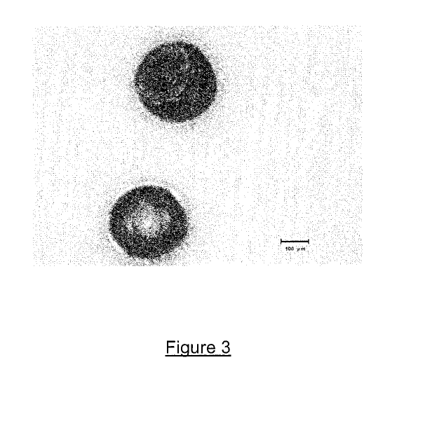

1. Each monomer is washed three times with a 10% NaOH (sodium hydroxide) solution, using a base volume equal to one third of the monomer amount to be purified (separate ampoules) (see FIG. 2).

2. Three washes of the organic phase with distilled water, whose volume corresponds to one third of the volume of the monomer. Verification that the wash water is not basic.

3. The organic phase is removed and anhydrous calcium chloride is added (CaCl₂ anh.).

4. The monomer is then passed through a column with basic alumina, for extracting the remaining inhibitor.

Once said procedure is finished, each monomer will be ready to be incorporated into the batch together with the initiator. The mass of the load (lampblack/carbon nanotubes/carbon nanotubes plus ceramic particles) is added to the monomeric phase and it is sonicated for 8 minutes. Then the initiator is added and sonication is performed again for 2 minutes, verifying that the AIBN has dissolved completely into the monomeric phase. Finally, the solution resulting from the monomers, the initiator, and the load, is incorporated into the reactor, which is already at 70° C. and under continuous agitation.

Right after the addition, the nitrogen pass is open, in order to generate the inert atmosphere. After about 20 min., the pass is closed, and all the inlets to the reactor are kept closed.

The agitation speed from start until 20 minutes from the addition of the monomeric phase is about 850 rpm, then the speed is incremented to 1048 rpm, until the end of polymerization after 5 hrs of reaction. From the time of the addition of the monomeric phase, agitation should not be interrupted, since otherwise the suspension will coalesce.

It must be controlled that during polymerization the agitating rod is correctly placed, as to avoid material projections.

Addition of the load was assayed in two different ways: either by incorporation into the aqueous phase, or by addition to the organic phase. It was noticed that the solid resulting from co-polymerization with addition of micro- or nano-load in the organic phase had an intense black color, and also that the reaction water was not darkened, which indicates that the particles were successfully incorporated into the solid. When the load particles were added to the aqueous phase, the resulting solid had a grayish coloration and load particles were found remaining into the reaction water. Accordingly, it was observed that a better addition of particles into the solid is achieved if the pigment is incorporated in the monomeric phase. The final step of the process can include (or not) one wash with water or other polar solvent as to eliminate the excess of aqueous dispersing agent.

In table 1 the amounts of reagents used in each reaction are indicated.

TABLE 1
Amounts used in the reaction.

| | |
|---|---|
| Amount | Percentage ⁽¹⁾ (%) |

| | | | |
|---|---|---|---|
| Distilled water | 435 | mL | — |
| Residual water | 435 | mL | — |
| PVA | 4.30 | g | 5.58 |
| NaCl | 2.12 | g | 2.75 |
| Lampblack⁽²⁾ | 0.10 | g | 0.13 |
| AIBN | 0.59 | g | 0.77 |
| Monomer/s | 49.2 | g | 63.81 |
| Divinylbenzene | 27.9 | g | 36.19 |

| | |
|---|---|
| Speed | Approx. 850 rpm for 20 min/ |
| | Approx. 1050 rpm for 4 h 40 min |
| Obtained mass #12/60 | 47.6 g |
| Yield | 71.13 g/L ⁽³⁾/80.3 g/L % ⁽⁴⁾ |

Note:
⁽¹⁾ The percentage is based on the monomer total mass used in the reaction.
⁽²⁾Lampblack used: Monarch 800
⁽³⁾ Yield grams of total mass per liter of water.
⁽⁴⁾ Yield of total mass obtained taking into account the used mass of monomers.

### 2) Treatment

Once completed the 5 hrs of the reaction, the solid is removed from the reactor and the residual water is separated, for use in a subsequent polymerization.

The obtained solid is successively washed with distilled water, including steps of washing at temperatures higher than 50° C., in order to eliminate all the polyvinyl alcohol that could have remained on the surface of the spheres. Afterwards, if the maximum degree of crosslinking was not achieved, a post-curation step can be performed. Finally, the resulting material is dried and weighted.

A new washing is performed with hot toluene, in order to eliminate the rests of mono-olefinic monomers, or small chains of non-crosslinked polymer which could have formed into the reactor. Again, the material is brought to vacuum stove for 2 hrs at 70° C. After this time, it is removed and weighted again (at room temperature). The mass difference between the two washes determinates the percentage of monomers, oligomers and lineal polymer slightly resistant to organic solvents.

Afterwards, the material is separated by size using the ASTM sieves #60-12, by means of mechanic agitator.

### Characterizations:

### Thermogravimetry

For analyzing the thermal stability of the solid, the thermogravimetric assays were performed in a TGA-51 Shimadzu equipment. Two jumps corresponding to the mass losses were observed, where the first one is situated about 420-450° C. with losses in the range of 85%-90%; and the second jump at 580-600° C. with mass losses in the range of 15%-10%.

### Differential Scanning Calorimetry

The glass-to-solid transition temperature was studied by DSC. The assays were performed in a TAQ Series™ Q20-1041 equipment. A ramp of 20° C./min was used, with prior erasing of the thermal history of the material. The glass transition temperature was higher than 140° C.

### Infrared Spectroscopy

The chemical structure of the different materials synthetized was analyzed by infrared spectroscopy FT-IR, in a Nicolet 550 equipment, using potassium bromide tablets. In all cases, signals were observed at round 3000 cm⁻¹, corresponding to the C—H bounds of the aromatic and aliphatic groups. Then, around 1600 cm⁻¹, the peak associated to the C═C stretching is found, while at 700 cm⁻¹, deformation of the C—H of the aromatic rings is found.

### Properties

Density: it was determined by using a conical 25 mL Hubbard pycnometer. For obtaining the solid density value, density of the used solvent (measured in the same pycnometer), mass of the solid to be analyzed, and the difference of weight between the pycnometer filled with solvent alone and later with the solvent and the solid inside are taken into account. The resulting density values ranged from 0.95 to 1.04 g/mL. The following assays were performed according to the norm:

### ISO 13503-2 Standard: Petroleum and Natural Gas Industries—Completion Fluids and Materials—

### Part 2:

### Measurement of Properties of Proppants Used in Hydraulic Fracturing and Gravel-Packing Operations

Granulometry: the size of the obtained solid was analyzed using ASTM sieves #12, #30 and #60. 90% by weight of the material is between sieves #12 and #60, according to ISO 13503-2 standard.

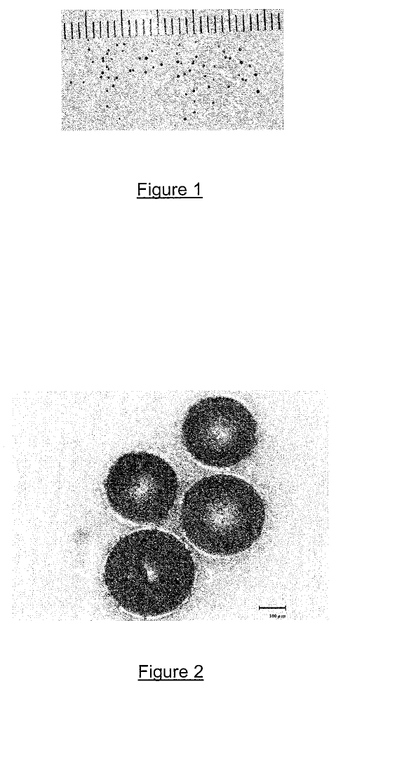

Geometry: A portion of the sample was observed under optical microscope OLYMPIKUS BX60M, and sphericity and roundness of the developed proppant was measured. The process consists in observing 20 particles under the microscope, with the appropriate magnification, and taking a value for each parameter. Said value results from comparing with the graphic representation of roundness vs. sphericity that is in section 7.2 of ISO1350-2 standard. Average values were between 0.5 and 1, for both parameters. See FIG. 1.

Mechanical strength: The strength to the compression assay was analyzed by applying 10,000 psi (compressive force over the container area in which the sample is confined). Samples with granulometry #16/30 were used, and their resulting fine residues are between 2 and 14% by mass (Section 11 ISO 1350-2 Standard). A hydraulic press was used in the assays.

Chemical resistance to mineral acids:

a) The assay consists in adding a portion of sample to a container with the corresponding acid, placing it into a sonicator for 15 minutes and filtering in previously tared filtering funnels. The filtrate is successively washed with water, until a neutral pH is achieved. Then, it is brought to vacuum stove. Once it is cold, it is weighted and the percentage of mass loss is calculated. Resistance to concentrated hydrochloric acid, 37%, was analyzed, resulting in a decrease of 0% to 2% by weight for granulometry #12/30.

b) Applying the same procedure described above chemical resistance to mineral acids was determined (concentrated hydrochloric acid, 37%) resulting in a decrease of 0% to 2% by weight for granulometry #30/60.

Chemical resistance to organic solvents:
a) The assay consists in adding a portion of sample to a container with the corresponding solvent, placing it into a sonicator for 15 minutes and filtering in previously tared filtering funnels. The filtrate is then brought to vacuum stove. Once it is cold, it is weighted and the percentage of mass loss is calculated. Resistance to solvents was analyzed, such as dichloromethane, toluene, benzene and octane, for granulometry #12/30 resulting in a decrease of 0% to 2% by weight.
b) Applying the same procedure described above chemical resistance to organic solvents was determined such as dichloromethane, toluene, octane, acetone, tetrahydrofurane, for granulometry #30/60 resulting in a decrease of 0% to 2% by weight. The invention comprises, without limitation, the following embodiments:
1) A polymeric material particle suitable for hydraulic fracture in a secondary gas and oil extraction wherein said particle comprises cross-linked polymer and loads.
2) The particle of embodiment 1, wherein said loads comprise microloads at a concentration of up to 0.13% (w/w).
3) The particle of embodiment 1, wherein said loads comprise nanoloads at a concentration of up to 0.03% (w/w).
4) The particle of embodiment 1, wherein said loads comprise a combination of nanoloads and microloads at a concentration of up to 0.13% (w/w).
5) The particle of embodiment 1, wherein has a density of between 0.95 and 1.04 g/mL.
6) The particle of embodiment 1, wherein has a density of up to 1.04 g/mL.
7) The particle of embodiment 1, wherein it has a mass loss lower than 2% when subjected to the action of organic solvents selected from the group comprising acetone, toluene, octane and tetrahydrofurane.
8) The particle of embodiment 1, wherein it has a mass loss lower than 2% when subjected to the action of organic acids such as hydrochloric acid.
9) The particle of embodiment 1, wherein it has a mass loss lower than 14% when subjected to a pressure of 20,000 psi.
10) The particle of embodiment 1, wherein said particle is a microparticle.
11) The particle of embodiment 1, wherein said loads are selected from the group comprising lampblack, carbon nanotubes, ceramic nanoparticles and combinations thereof.
12) The particle of embodiment 1, wherein said loads comprise carbon nanotubes and ceramic nanoparticles.
13) The particle of embodiment 1, wherein said particle comprises a reticulated polymeric material in which the polymer presents a repetitive structure of formula I:

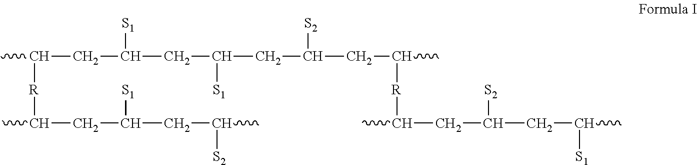

wherein S₁ and S₂ are substituent groups of olefins, and R₂ is an alkyl or aryl from a crosslinking monomer.
14) A process for obtaining the particle of embodiment 1, wherein said process comprises a polymerization in suspension which comprises the following steps:
a. mixing a stabilizer and a dispersing agent in water and heating;
b. adding a mixture of at least one monomer, loads and one initiator to the aqueous solution of step a;
c. making react the mixture at a temperature higher than 50° C. under continuous agitation and for a time of at least 3 hours;
d. once the polymerization reaction is completed, filtering and washing with water the obtained particles of the invention.
15) The process of embodiment 14, wherein in step a said stabilizer is selected from the group comprising sodium chloride, potassium chloride, an inorganic salt and mixtures thereof; while said dispersing agent is selected from the group comprising polyvinylic alcohol, sodium polyacrylates, cellulose polymers, hydroxyethyl cellulose (Natrosol), hydroxypropyl cellulose (Klucel), poly (N,N-dialyl-N,N-dimethyl ammonium chloride) (Cat-Floc B), gelatin, polyalcohols or combinations thereof.
16) The process of embodiment 14, wherein said process is isothermal and is carried out at a temperature of at least 50° C.
17) The process of embodiment 14, wherein said process is isothermal and is carried out at a temperature of 70° C.
18) The process of embodiment 14, wherein the mixture of step b comprises at least two monomers.
19) The process of embodiment 18, wherein a first monomer is a bis-olefin selected from the group comprising polyfunctional acrylates, trimethacrylate, trimethylpropane, diacrylate, pentaeritrithol tetramethylacrylate divinylbenzene, dimethacrylate ethylene glycol, and combinations thereof, and a second monomer is a mono-olefinic one, selected from the group comprising acrylates, vinyl acetate, styrene, vinylnaphthalenes, vinyltoluene, allylic esters, vinyl chloride olefins, and combinations thereof.
20) The process of embodiment 19, wherein said first monomer comprises a concentration of between 20 and 55% by weight of the monomer.
21) The process of embodiment 18, wherein a second monomer is a mono-olefinic selected from the group comprising acrylates, vinyl acetate, styrene, vinylnaphtalenes, vinyl toluene, allylic esters, vinyl chloride olefins, and combinations thereof.
22) The process of embodiment 18 wherein said process comprises two or more monomers comprising a vinyl group.
23) The process of embodiment 14, wherein said initiator of the mixture of step b comprises azobisisobutyronitrile (AIBN).
24) The process of embodiment 14, wherein said loads of step b are selected from the group comprising lampblack, carbon nanotubes, ceramic nanoparticles and combinations of any of the preceding.
25) The process of embodiment 14, wherein said loads of step b are nanoloads and comprise carbon nanotubes and ceramic nanoparticles.
26) The process of embodiment 14, wherein in step b said loads are microloads and comprise a concentration of between 0.1 and 0.2 w/w % relative to the weight of the monomers.
27) The process of embodiment 14, wherein in step b said loads are nanoloads and comprise a concentration lower than 0.03% w/w equivalent to 0.015% v/v.
28) The process of embodiment 14, wherein in step b said loads are comprise a combination of microloads at a concentration lower than 0.12% w/w and nanoloads at a concentration of up to 0.01% w/w.
29) The process of embodiment 14, wherein step b comprises dispersion of said loads in monomer solution under sonication in absence of the dispersing agent.
30) The process of embodiment 14, wherein the aqueous phase resulting from the reaction medium can be reused.
31) The process of embodiment 14, wherein said stabilizer of the aqueous phase of step a comprises a neutral inorganic salt at a concentration lower than 4% by weight as salt.
32) The process of embodiment 14, wherein said process comprises a neutral pH in the aqueous phase of step a.
33) The process of embodiment 14, wherein said water of step a comprises the aqueous phase of a reaction medium used in a previous polymerization.
34) The process of embodiment 14, wherein agitation comprises at least a rotation speed in the order of 850 rpm during the manufacturing process.

### EXAMPLES

### Example 1

In Example 1, it was used a 1 liter capacity reactor with four inlets, placing on each a refrigerant, thermocouple, nitrogen entrance, and at the center thereof a mechanical agitator. Heating is achieved by a heating mat. Synthesis consists in a co-polymerization in suspension, comprising an aqueous phase and a monomeric phase. The aqueous phase is formed by distilled water, sodium chloride as stabilizer, polyvinylic alcohol as dispersing agent. Meanwhile the monomeric phase consists, in this example, of two monomers, styrene and divinylbenzene, an initiator as azobisisobutyronitrile (AIBN) and a load of lampblack.

Distilled water, along with sodium chloride and the polyvinylic alcohol are placed into the reactor, and are brought to 70° C., in order to form the aqueous phase. When that temperature is reached, 10 mL of the solution are removed. To that fraction, the mass of lampblack is added, and is taken to the sonicator for 10 minutes. The resulting solution is taken back to the reactor.

In another batch, the monomers and the initiator are mixed, ensuring the dissolution of the initiator into the organic phase. Then, the mixture is incorporated into the reactor, which presents the aqueous phase at the desired temperature and under continuous stirring.

The entrance of nitrogen in kept open for about 15 minutes as from the addition of the organic phase, and is then closed, keeping an inert atmosphere within the reactor.

The agitator should not be stopped from the time of adding the monomeric phase until the reaction is considered as completed, since otherwise the suspension will coalesce.

Temperature must be kept around 70° C. at all times during polymerization.

Agitation speed from the start until 20 minutes counted since the addition of the monomeric phase is about 850 rpm, after which the speed is increased to 1050 rpm, until the polymerization is completed after 5 hrs of reaction. Agitation should not be stopped from the time of adding the monomeric phase as otherwise the suspension will coalesce.

After the polymerization is complete, the polymer is removed, filtered and successively washed with distilled water in order to eliminate the remaining stabilizing agent.

In table 2, the employed amounts are indicated.

TABLE 2
Polymerization data from Example 1.

| | |
|---|---|
| Amount | Percentage¹ (%) |

Aqueous phase

| | | | |
|---|---|---|---|
| Distilled water | 435 | mL | — |
| Residual water | 435 | mL | — |
| Sodium chloride | 2.12 | g | 2.75% |
| Polyvinylic alcohol | 4.30 | g | 5.58% |
| Lampblack | 0.10 | g | 0.13% |

Organic phase

| | | | |
|---|---|---|---|
| Styrene | 49.20 | g | 63.81% |
| Divinylbenzene | 27.90 | g | 36.19% |
| AIBN | 0.59 | g | 0.77% |

¹Percentages are by weight and are informed based on the used total mass of monomer.

### Example 2

In Example 2, a similar equipment to the one used in Example 1 was employed, using a reactor with 1 liter capacity reactor with four inlets, placing on each a refrigerant, thermocouple, nitrogen entrance, and at the center thereof a mechanical agitator. Heating is achieved by a heating mat. Synthesis consists in a co-polymerization in suspension, comprising an aqueous phase and a monomeric phase. The aqueous phase is formed by distilled water, sodium chloride as stabilizer, polyvinylic alcohol as dispersing agent. Meanwhile, the monomeric phase consists, in this example, of two monomers, methyl methacrylate and divinylbenzene, an initiator as azobisisobutyronitrile (AIBN) and a load of lampblack.

Distilled water, along with sodium chloride and the polyvinylic alcohol are placed into the reactor, and are brought to 70° C., in order to form the aqueous phase.

In another batch, the monomers and the load are mixed. After 8 minutes of sonication, the initiator is added and sonication continues for two additional minutes, ensuring dissolution of the initiator into the organic phase. Lastly, said phase is incorporated into the reactor which has the aqueous phase at the desired temperature and under continuous stirring.

The entrance of nitrogen in kept open for about 15 minutes as from the addition of the organic phase, and is then closed, keeping an inert atmosphere within the reactor.

The agitator should not be stopped from the time of adding the monomeric phase until the reaction is considered as completed, since otherwise the suspension will coalesce.

Temperature must be kept around 70° C. at all times during polymerization.

Agitation speed from the start until 20 minutes counted since the addition of the monomeric phase is about 850 rpm, after which the speed is increased to 1050 rpm, until the polymerization is completed after 5 hrs of reaction. Agitation should not be stopped from the time of adding the monomeric phase as otherwise the suspension will coalesce.

After the polymerization is complete, the polymer is removed, filtered and successively washed with distilled water in order to eliminate the remaining stabilizing agent.

In table 3, the employed amounts are indicated.

TABLE 3
Polymerization data from Example 2.

| | |
|---|---|
| Amount | Percentage¹ (%) |

Aqueous phase

| | | | |
|---|---|---|---|
| Distilled water | 435 | mL | — |
| Residual water | 435 | mL | |
| Sodium chloride | 2.12 | g | 2.78 |
| Polyvinylic alcohol | 4.3 | g | 5.63 |
| Lampblack | 0.10 | g | 0.13 |

Organic phase

| | | | |
|---|---|---|---|
| Methyl methacrylate | 47.20 | g | 61.86 |
| Divinylbenzene | 29.10 | g | 38.14 |
| AIBN | 0.59 | g | 0.77 |

¹Percentages are by weight and are informed based on the total mass of monomer used.

### Example 3

Example 3, consisted in the co-polymerization of the three monomers, one of them with crosslinking ability, and the addition of loads to the reaction. A similar equipment to the one used in Example 1 was used, using a reactor with 1 liter capacity reactor with four inlets, placing on each a refrigerant, thermocouple, nitrogen entrance, and at the center thereof a mechanical agitator. Heating is achieved by a heating mat. Synthesis consists in a co-polymerization in suspension, comprising an aqueous phase and a monomeric phase. The aqueous phase is formed by distilled water, sodium chloride as stabilizer, polyvinylic alcohol as dispersing agent. Meanwhile, the monomeric phase consists, in this example, of two monomers, styrene, methyl methacrylate and divinylbenzene, an initiator as azobisisobutyronitrile (AIBN) and a load of lampblack.

Distilled water, along with sodium chloride and the polyvinylic alcohol are placed into the reactor, and are brought to 70° C., in order to form the aqueous phase.

In a batch, the monomers and the load are mixed. Then the initiator is added, ensuring its dissolution into the organic phase. Then, the solution is incorporated into the reactor, which presents the aqueous phase at the desired temperature and under continuous stirring at about 850 rpm.

The entrance of nitrogen in kept open for about 15 minutes as from the addition of the organic phase, and is then closed, keeping an inert atmosphere within the reactor. Then, the agitation speed is increased to 1050 rpm.

The agitator should not be stopped from the time of adding the monomeric phase until the reaction is considered as completed, since otherwise the suspension will coalesce.

Temperature must be kept around 70° C. at all times during polymerization, i.e. during the course of the 5 hrs. The addition of the monomeric phase is considered as the start of polymerization.

After the polymerization is complete, the polymer is removed, filtered and successively washed with distilled water in order to eliminate the remaining stabilizing agent.

In table 4, the employed amounts are indicated.

TABLE 4
Polymerization data from Example 3.

| | |
|---|---|
| Amount | Percentage¹ (%) |

Aqueous phase

| | | | |
|---|---|---|---|
| Distilled water | 435 | mL | — |
| Residual water | 435 | mL | |
| Sodium chloride | 2.76 | g | 2.75 |
| Polyvinylic alcohol | 5.59 | g | 5.58 |
| Lampblack | 0.10 | g | 0.13 |

Organic phase

| | | | |
|---|---|---|---|
| Methyl methacrylate/styrene | 48.9 | g | 63.59 |
| Divinylbenzene | 28.0 | g | 36.41 |
| AIBN | 0.59 | g | 0.77 |

¹Percentages are by weight and are informed based on the total mass of monomer used.

### Example 4

Example 4, consisted in the co-polymerization of the two monomers, one of them with crosslinking ability, and the addition of loads to the reaction. A similar equipment to the one used in Example 1 was used, using a reactor with 1 liter capacity reactor with four inlets, placing on each a refrigerant, thermocouple, nitrogen entrance, and at the center thereof a mechanical agitator. Heating is achieved by a heating mat. Synthesis consists in a co-polymerization in suspension, comprising an aqueous phase and a monomeric phase. The aqueous phase is formed by distilled water, sodium chloride as stabilizer, polyvinylic alcohol as dispersing agent. Meanwhile, the monomeric phase consists, in this example, of two monomers, styrene and divinylbenzene, an initiator as azobisisobutyronitrile (AIBN) and one load of carbon nanotubes.

A procedure similar to the described before was followed. In table 5, the employed amounts are indicated.

TABLE 5
Polymerization data from Example 4.

| | |
|---|---|
| Amount | Percentage¹ (%) |

Aqueous phase

| | | | |
|---|---|---|---|
| Distilled water | 435 | mL | — |
| Residual water | 435 | mL | |
| Sodium chloride | 2.12 | g | 2.754 |
| Polyvinylic alcohol | 4.30 | g | 5.56 |
| Lampblack | 0.91 | g | 0.12 |
| Carbon nanotubes | 0.01 | g | 0.01 |

Organic phase

| | | | |
|---|---|---|---|
| Styrene | 49.3 | g | 63.70 |
| Divinylbenzene | 28.1 | g | 36.30 |
| AIBN | 0.59 | g | 0.77 |

¹Percentages are by weight and are informed based on the used total mass of monomer

### Example 5

Example 5, consisted in the co-polymerization of the two monomers, one of them with crosslinking ability, and the addition of loads to the reaction. A similar equipment to the one used in Example 1 was used, using a reactor with 1 liter capacity reactor with four inlets, placing on each a refrigerant, thermocouple, nitrogen entrance, and at the center thereof a mechanical agitator. Heating is achieved by a heating mat. Synthesis consists in a co-polymerization in suspension, comprising an aqueous phase and a monomeric phase. The aqueous phase is formed by distilled water, sodium chloride as stabilizer, polyvinylic alcohol as dispersing agent. Meanwhile, the monomeric phase consists, in this example, of two monomers, styrene and divinylbenzene, an initiator as azobisisobutyronitrile (AIBN) and two loads, one of lampblack and the other of carbon nanotubes.

A procedure similar to the described before was followed. In table 6, the employed amounts are indicated.

TABLE 6
Polymerization data from Example 5.

| | |
|---|---|
| Amount | Percentage¹ (%) |

Aqueous phase

| | | | |
|---|---|---|---|
| Distilled water | 435 | mL | — |
| Residual water | 435 | mL | |
| Sodium chloride | 2.12 | g | 2.754 |
| Polyvinylic alcohol | 4.30 | g | 5.56 |
| Lampblack | 0.91 | g | 0.12 |
| Carbon nanotubes | 0.01 | g | 0.01 |

Organic phase

| | | | |
|---|---|---|---|
| Styrene | 49.3 | g | 63.70 |
| Divinylbenzene | 28.1 | g | 36.30 |
| AIBN | 0.59 | g | 0.77 |

¹Percentages are by weight and are informed based on the total mass of monomer used.

### Example 6

Example 6, consisted in the co-polymerization of the two monomers, one of them with crosslinking ability, and the addition of loads to the reaction. A similar equipment to the one used in Example 1 was used, using a reactor with 1 liter capacity reactor with four inlets, placing on each a refrigerant, thermocouple, nitrogen entrance, and at the center thereof a mechanical agitator. Heating is achieved by a heating mat. Synthesis consists in a co-polymerization in suspension, comprising an aqueous phase and a monomeric phase. The aqueous phase is formed by distilled water, sodium chloride as stabilizer, polyvinylic alcohol as dispersing agent. Meanwhile, the monomeric phase consists, in this example, of two monomers, styrene and divinylbenzene, an initiator as azobisisobutyronitrile (AIBN) and one load of carbon nanotubes plus ceramic nanoparticles.

A procedure similar to the described before was followed. In table 7, the employed amounts are indicated.

TABLE 7
Polymerization data from Example 6.

| | |
|---|---|
| Amount | Percentage¹ (%) |

Aqueous phase

| | | | |
|---|---|---|---|
| Distilled water | 435 | mL | — |
| Residual water | 435 | mL | |
| Sodium chloride | 2.11 | g | 2.75 |
| Polyvinylic alcohol | 4.30 | g | 5.58 |
| Carbon nanotubes plus | 0.02 | g | 0.03 |
| ceramic nanoparticles | | | |

Organic phase

| | | | |
|---|---|---|---|
| Styrene | 49.4 | g | 63.82 |
| Divinylbenzene | 28.0 | g | 36.18 |
| AIBN | 0.59 | g | 0.77 |

¹Percentages are by weight and are informed based on the total mass of monomer used.

### Example 7

Example 7, consisted in the co-polymerization of the two monomers, one of them with crosslinking ability, and the addition of loads to the reaction. A similar equipment to the one used in Example 1 was used, using a reactor with 1 liter capacity reactor with four inlets, placing on each a refrigerant, thermocouple, nitrogen entrance, and at the center thereof a mechanical agitator. Heating is achieved by a heating mat. Synthesis consists in a co-polymerization in suspension, comprising an aqueous phase and a monomeric phase. The aqueous phase is formed by distilled water, sodium chloride as stabilizer, polyvinylic alcohol as dispersing agent. Meanwhile, the monomeric phase consists, in this example, of two monomers, styrene and divinylbenzene, an initiator as azobisisobutyronitrile (AIBN) and two loads, one of lampblack and the other of carbon nanotubes plus ceramic nanoparticles.

A procedure similar to the described before was followed. In table 8, the employed amounts are indicated.

TABLE 8
Polymerization data from Example 7.

| | |
|---|---|
| Amount | Percentage¹ (%) |

Aqueous phase

| | | | |
|---|---|---|---|
| Distilled water | 435 | mL | — |
| Residual water | 435 | mL | |
| Sodium chloride | 2.11 | g | 2.75 |
| Polyvinylic alcohol | 4.30 | g | 5.58 |
| Lampblack/ | 0.91 | g | 0.12 |
| Carbon nanotubes plus | 0.01 | g | 0.01 |
| ceramic nanoparticles | | | |

Organic phase

| | | | |
|---|---|---|---|
| Styrene | 49.3 | g | 63.70 |
| Divinylbenzene | 28.1 | g | 36.30 |
| AIBN | 0.59 | g | 0.77 |

¹Percentages are by weight and are informed based on the total mass of monomer used.

Comparative Table of Densities

In Table 9 densities of the different experiments are presented

TABLE 9
Chart of the densities of the samples from the different experiments

| Experiment | δ octane (g/mL) | δ sample (g/mL) |
|---|---|---|
| 1 | 0.6982 | 0.9605 |
| 2 | 0.6946 | 1.0400 |
| 3 | 0.6957 | 0.9741 |
| 4 | 0.6992 | 0.9453 |
| 5 | 0.6946 | 0.9732 |
| 6 | 0.6982 | 0.9977 |
| 7 | 0.6982 | 0.9877 |

Comparative Table of Resistance to Solvents and Acids

In Table 10 mass losses from the different experiments when subjected to the following solvents and acids are presented.

TABLE 10
Chart of the mass losses of the samples
from the different experiments.

| | Percentage mass loss/% | | | | |
|---|---|---|---|---|---|
| | | | | Tetrahydro- | Hydrochloric |
| Experiment | Acetone | Toluene | Octane | furane | acid |
| 1 | 1.3 | 0.58 | 1.27 | 0.66 | 0.93 |
| 2 | 0.6 | 0.30 | 0.97 | 0.30 | 0.53 |
| 3 | 1.0 | 0.45 | 1.15 | 0.45 | 0.77 |
| 4 | 1.8 | 1.52 | 1.04 | 1.54 | 1.38 |
| 5 | 1.5 | 1.01 | 1.11 | 1.08 | 1.15 |
| 6 | 1.9 | 0.64 | 1.39 | 1.96 | 0.82 |
| 7 | 1.6 | 0.60 | 1.35 | 1.13 | 0.87 |

Comparative Table of Strength to Pressure

In table 11 mass losses of the different experiments when subjected to a pressure of 20,000 psi are presented.

TABLE 11
Chart of the mass losses of the samples from the different
experiments facing a force of 20,000 psi.

| Experiment | Percentage loss (%) |
|---|---|
| 1 | 2.2 |
| 2 | 3.6 |
| 3 | 2.9 |
| 4 | 6.3 |
| 5 | 4.3 |
| 6 | 4.8 |
| 7 | 3.5 |

1) A polymeric material particle suitable for hydraulic fracture in a secondary gas and oil extraction wherein said particle comprises cross-linked polymer and loads.

2) The particle of claim 1, wherein said loads comprise microloads at a concentration of up to 0.13% (w/w), nanoloads at a concentration of up to 0.03% (w/w), or a combination of nanoloads and microloads at a concentration of up to 0.13% (w/w).

3) The particle of claim 1, wherein has a density of between 0.95 and 1.04 g/mL.

4) The particle of claim 1, wherein said particle is a microparticle.

5) The particle of claim 1, wherein said loads are selected from the group comprising lampblack, carbon nanotubes, ceramic nanoparticles and combinations thereof.

6) The particle of claim 1, wherein said loads comprise carbon nanotubes and ceramic nanoparticles.

7) The particle of claim 1, wherein said particle comprises a reticulated polymeric material in which the polymer presents a repetitive structure of formula I: 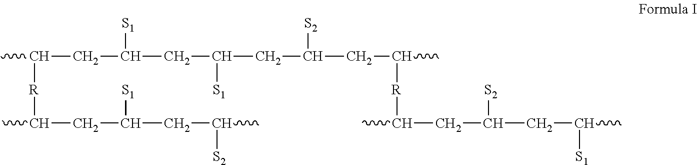
wherein S₁ and S₂ are substituent groups of olefins, and R₂ is an alkyl or aryl from a crosslinking monomer.

8) A process for obtaining the particle of claim 1, wherein said process comprises a polymerization in suspension which comprises the following steps:
a. mixing a stabilizer and a dispersing agent in water and heating;
b. adding a mixture of at least one monomer, loads and one initiator to the aqueous solution of step a;
c. making react the mixture at a temperature higher than 50° C. under continuous agitation and for a time of at least 3 hours;
d. once the polymerization reaction is completed, filtering and washing with water the obtained particles of the invention.

9) The process of claim 8, wherein in step a said stabilizer is selected from the group comprising sodium chloride, potassium chloride, an inorganic salt and mixtures thereof; while said dispersing agent is selected from the group comprising polyvinylic alcohol, sodium polyacrylates, cellulose polymers, hydroxyethyl cellulose (Natrosol), hydroxypropyl cellulose (Klucel), poly (N,N-dialyl-N,N-dimethyl ammonium chloride) (Cat-Floc B), gelatin, polyalcohols or combinations thereof.

10) The process of claim 8, wherein said process is isothermal and is carried out at a temperature of at least 50° C.

11) The process of claim 8, wherein said process is isothermal and is carried out at a temperature of 70° C.

12) The process of claim 8, wherein the mixture of step b comprises at least two monomers.

13) The process of claim 12, wherein a first monomer is a bis-olefin selected from the group comprising polyfunctional acrylates, trimethacrylate, trimethylpropane, diacrylate, pentaeritrithol tetramethylacrylate divinylbenzene, dimethacrylate ethylene glycol, and combinations thereof, and a second monomer is a mono-olefinic one, selected from the group comprising acrylates, vinyl acetate, styrene, vinylnaphthalenes, vinyltoluene, allylic esters, vinyl chloride olefins, and combinations thereof.

14) The process of claim 13, wherein said first monomer comprises a concentration of between 20 and 55% by weight of the monomer.

15) The process of claim 12 wherein said process comprises two or more monomers comprising a vinyl group.

16) The process of claim 8, wherein said initiator of the mixture of step b comprises azobisisobutyronitrile (AIBN).

17) The process of claim 8, wherein said loads of step b are selected from the group comprising lampblack, carbon nanotubes, ceramic nanoparticles and combinations of any of the preceding.

18) The process of claim 8, wherein said loads of step b are nanoloads and comprise carbon nanotubes and ceramic nanoparticles.

19) The process of claim 8, wherein in step b said loads:
a. are microloads and comprise a concentration of between 0.1 and 0.2 w/w % relative to the weight of the monomers,
b. are nanoloads and comprise a concentration lower than 0.03% w/w equivalent to 0.015% v/v, or
c. comprise a combination of microloads at a concentration lower than 0.12% w/w and nanoloads at a concentration of up to 0.01% w/w.

20) The process of claim 8, wherein step b comprises dispersion of said loads in monomer solution under sonication in absence of the dispersing agent.

21) The process of claim 8, wherein said stabilizer of the aqueous phase of step a comprises a neutral inorganic salt at a concentration lower than 4% by weight as salt.

22) The process of claim 8, wherein said process comprises a neutral pH in the aqueous phase of step a.

23) The process of claim 8, wherein said water of step a comprises the aqueous phase of a reaction medium used in a previous polymerization.

24) The process of claim 8, wherein agitation comprises at least a rotation speed in the order of 850 rpm during the manufacturing process.
